(19) United States
(12) Patent Application Publication
(10) Pub. No.: US 2015/0337402 A1
(43) Pub. Date: Nov. 26, 2015

(54) PLANT-BIOMASS HYDROLYSIS METHOD

(71) Applicants: SHOWA DENKO K. K., Tokyo (JP); NATIONAL UNIVERSITY CORPORATION HOKKAIDO UNIVERSITY, Sapporo-shi, Hokkaido (JP)

(72) Inventors: Ichiro FUJITA, Tokyo (JP); Tadashi YONEDA, Tokyo (JP); Atsushi FUKUOKA, Sapporo-shi, Hokkaido (JP); Hirokazu KOBAYASHI, Sapporo-shi, Hokkaido (JP); Mizuho YABUSHITA, Sapporo-shi, Hokkaido (JP)

(73) Assignees: SHOWA DENKO K.K., Tokyo (JP); National University Corporation Hokkaido University, Sapporo-shi, Hokkaido (JP)

(21) Appl. No.: 14/653,004

(22) PCT Filed: Nov. 19, 2013
(86) PCT No.: PCT/JP2013/081182

§ 371 Date: Jun. 17, 2015

(30) Foreign Application Priority Data
Dec. 18, 2012 (JP) 2012-275516

(51) Int. Cl. C13K 1/02; C13K 13/00

(52) U.S. Cl. CPC C13K 1/02; C13K 13/002

(57) ABSTRACT

A method for hydrolyzing a plant biomass, which includes a first process of heating a mixture containing a plant biomass, a solid catalyst, acid and water, and a second process for heating the mixture containing a solid containing a plant biomass and a catalyst separated from the reaction solution after the first process, acid and water, wherein the highest heating temperature in the second process is higher than that in the first process; and a method for producing glucose and xylose using the above-mentioned hydrolyzing method. In the method, both of glucose and xylose can be obtained efficiently from an actual biomass.

### TECHNICAL FIELD

The present invention relates to a method of hydrolyzing a plant biomass. Particularly, the present invention relates to a hydrolysis method for obtaining glucose and xylose at a high yield by hydrothermal treatment of a plant biomass.

### BACKGROUND ART

In recent years, many studies have been made on use of useful substances converted from recyclable biomass resources produced from plants and the like. Cellulose contained in a plant biomass as a main component is a polymer formed of β-1,4-linked glucose units. Since the cellulose forms hydrogen bonds within and between molecules and exhibits high crystallinity, the cellulose is characterized in being insoluble in water or a usual solvent and being persistent. In recent years, a study on a reaction which can reduce an environmental burden has been made as a cellulose hydrolysis method instead of a sulfuric acid method or an enzyme method.

For example, JP H10-327900 A (Patent Document 1) discloses a method of hydrolyzing reagent-grade cellulose powder by bringing it into contact with hot-water under pressure heated to 200 to 300° C. JP 2009-201405 A (Patent Document 2) discloses a method using an activated carbon solid acid catalyst subjected to sulfuric acid treatment as the solid catalyst in the reaction by heating with water (hydrothermal reaction). Furthermore, JP 2011-206044 A (Patent Document 3) discloses a method which enables a glucose yield of 60% or more by bringing a raw material containing cellulose and an aqueous solution containing an inorganic acid into contact with each other, followed by heating and pressure treatment. However, these patent documents only describe an example using genuine cellulose as a raw material and do not mention a method for obtaining a high saccharification yield by using an actual biomass.

In order to improve the practical utility of the saccharification technology by hydrothermal reaction, it is necessary to establish technology which can realize a high saccharification yield not only in the case of using a reagent-grade cellulose but also in the case of using an actual biomass material.

In addition to cellulose, non-cellulose components such as hemicellulose as being polysaccharide of pentose and lignin as being a non-sugar component coexist in an actual biomass. Therefore, there is a problem of decrease in the purity of the sugar solution to be obtained due to the decomposed product of coexisting components contained in a reaction solution and a problem of decrease in hydrolysis performance due to the coexisting component in the hydrolysis of cellulose into glucose compared to the case of using a reagent-grade material.

From hemicellulose as being another sugar coexisting with cellulose, it is possible to obtain xylose, which can be used for food as a sweetener and the like, as a fermentation feed stock or as a raw material of furfural and xylitol, by hydrolysis. If saccharification of hemicellulose is conducted at the time of saccharifying cellulose and xylose is fractionated, it creates high added value in use of the biomass.

For the above-mentioned reasons, it has been desired to establish a saccharification method that can fractionate glucose and xylose to obtain both at a high yield in a hydrolysis reaction of a plant biomass through a hydrothermal reaction.

### PRIOR ART

### Patent Document

Patent Document 1: JP H10-327900 A

Patent Document 2: JP 2009-201405 A

Patent Document 3: JP 2011-206044 A

### DISCLOSURE OF THE INVENTION

### Problems to be Solved by the Invention

An objective of the present invention is to provide a method of obtaining glucose and xylose from an actual biomass at a high yield by a method of hydrolyzing a plant biomass.

### Means to Solve the Problem

The present inventors made intensive studies to achieve the above objective. As a result, the present inventors have found that in hydrolysis of a plant biomass through a hydrothermal treatment, both of xylose and glucose can be fractionated and obtained at a high yield by dividing the process of heating the mixture of a solid catalyst which catalyzes the hydrolysis, inorganic acid and water into two processes: i.e. a process for mainly obtaining xylose and a process for mainly obtaining glucose, and have accomplished the invention.

That is, the present invention provides a method for hydrolyzing a plant biomass in the following [1] to [9], a method for producing glucose in the following [10] and a method for producing xylose in the following [11].

[1] A method for hydrolyzing a plant biomass, comprising a first process of heating a mixture containing a plant biomass, a solid catalyst, inorganic acid and water, and a second process for heating the mixture containing a solid content separated from the reaction solution after the first process, acid and water; wherein the highest heating temperature in the second process is higher than that in the first process.
[2] The method for hydrolyzing a plant biomass as described in [1] above, wherein the highest heating temperature is 140 to 210° C. and the retention time at the temperature is 0 to 60 minutes in the first process, and the highest heating temperature is 180 to 250° C. and the retention time at the temperature is 0 to 60 minutes in the second process.
[3] The method for hydrolyzing a plant biomass as described in [1] or [2] above, wherein the pH of the mixture containing a plant biomass, a solid catalyst, acid and water right before the first process is 1.0 to 4.0.
[4] The method for hydrolyzing a plant biomass as described in any one of [1] to [3] above, wherein the acid is at least one member selected from inorganic mineral acid, organic carboxylic acid and organic sulfonic acid.
[5] The method for hydrolyzing a plant biomass as described in [4] above, wherein the inorganic mineral acid is at least one member selected from hydrochloric acid, sulfuric acid, nitric acid, phosphoric acid and boric acid.
[6] The method for hydrolyzing a plant biomass as described in any one of [1] to [5] above, wherein the solid catalyst is a carbon material.
[7] The method for hydrolyzing a plant biomass as described in [6] above, wherein the carbon material is alkali-activated carbon, steam-activated carbon, or mesoporous carbon.
[8] The method for hydrolyzing a plant biomass according to any one of [1] to [7] above, wherein the plant biomass contains cellulose and/or hemicellulose.
[9] The method for hydrolyzing a plant biomass according to any one of [1] to [8] above, wherein the plant biomass is subjected to delignification treatment.
[10] A method for producing glucose, characterized in using the method for hydrolyzing a plant biomass described in any one of [1] to [9] above.
[11] A method for producing xylose, characterized in using the method for hydrolyzing a plant biomass described in any one of [1] to [9] above.

### Effects of the Invention

According to the method for hydrolyzing a plant biomass of the present invention, glucose and xylose can be obtained at a high yield from an actual biomass.

### BRIEF DESCRIPTION OF DRAWINGS

FIG. 1 shows the results of the hydrolysis in the first process in Examples 1 to 4 and Comparative Examples 1 to 5.

FIG. 2 shows the results of the hydrolysis in the first process and the second process in Examples 1 to 4 and Comparative Example 5.

FIG. 3 shows the results of the total hydrolysis processes in Examples 1 to 4 and Comparative Examples 1 to 5.

### MODE FOR CARRYING OUT THE INVENTION

The present invention is hereinafter described in detail.

The method for hydrolyzing a plant biomass of the present invention is characterized in conducting the process of heating the mixture containing a solid catalyst which catalyzes the hydrolysis, inorganic acid and water twice by changing the heating conditions.

### [Plant Biomass (Solid Substrate)]

The term “biomass” generally refers to “recyclable organic resource of biologic origin, excluding fossil resources.” In the present invention, the “plant biomass” is, for example, a biomass such as rice straw, wheat straw, sugarcane leaves, chaff, bagasse, a broadleaf tree, bamboo, a coniferous tree, kenaf, furniture waste wood, construction waste wood, waste paper, or a food residue, which mainly contains cellulose or hemicellulose. In the present invention, a plant biomass is used as a solid substrate in the hydrolysis reaction.

As a solid substrate, a plant biomass may be used as it is. Or a plant biomass to be used may be one that is obtained by subjecting the plant biomass to the delignification treatment such as alkali steam treatment, alkaline sulfite steam treatment, neutral sulfite steam treatment, alkaline sodium sulfide steam treatment, ammonia steam treatment, sulfuric acid steam treatment and water-vapor steam treatment, and then to treatment to decrease the lignin content by performing the operations of neutralization, washing with water, dehydration and drying, and that contains two or more members out of cellulose, hemicellulose, and lignin (hereinafter abbreviated as “an actual biomass”). Further, the plant biomass may be industrially prepared cellulose, xylan, cello-oligosaccharide, or xylooligosaccharide (hereinafter abbreviated as “a reagent biomass”). The plant biomass may contain an ash content such as silicon, aluminum, calcium, magnesium, potassium, or sodium, which is derived from the plant biomass, as an impurity.

The plant biomass may be in a dry form or a wet form, and may be crystalline or non-crystalline. The size of the plant biomass is not particularly limited as long as the pulverization treatment of the biomass can be performed. From the viewpoint of the pulverization efficiency, a particle diameter is preferably 20 μm or more and several thousand micrometers or less.

[Solid Catalyst]

In the hydrolysis method by hydrothermal treatment of the present invention, a solid catalyst may be used. The solid catalyst is not particularly limited as long as the catalyst can hydrolyze the plant biomass polysaccharides, but preferably has an activity to hydrolyze a glycoside bond typified by β-1,4 glycosidic bonds between glucose units that form cellulose contained as a main component.

Examples of the solid catalyst include a carbon material and a transition metal. One kind of those solid catalysts may be used alone, or two or more kinds thereof may be used in combination.

Examples of the carbon material include activated carbon, carbon black, and graphite. One kind of those carbon materials may be used alone, or two or more kinds thereof may be used in combination. Regarding the shape of the carbon material, from the viewpoint of improving reactivity by increasing an area for contact with a substrate, the carbon material is preferably porous and/or particulate. From the viewpoint of promoting hydrolysis by expressing an acid site, the carbon material preferably has a surface functional group such as a phenolic hydroxyl group, a carboxyl group, a sulfonyl group, or a phosphate group. Examples of a porous carbon material having a surface functional group include a wood material such as coconut husk, bamboo, pine, walnut husk, or bagasse; and activated carbon prepared by a physical method involving treating coke or phenol at high temperature with a gas such as steam, carbon dioxide or air, or by a chemical method involving treating coke or phenol at high temperature with a chemical reagent such as an alkali or zinc chloride. Among these carbon materials, preferred are alkali-activated carbon, steam-activated carbon and mesoporous carbon.

A transition metal selected from the group consisting of ruthenium, platinum, rhodium, palladium, iridium, nickel, cobalt, iron, copper, silver and gold may be used singly or two or more thereof may be used in combination. One selected from platinum group metals including ruthenium, platinum, rhodium, palladium, and iridium is preferred from the viewpoint of having a high catalytic activity, and one selected from ruthenium, platinum, palladium, and rhodium is particularly preferred from the viewpoints of having a high rate of conversion of cellulose and selectivity of glucose.

[Pulverization of a Solid Substrate]

Cellulose, which is a main component of polysaccharides contained in a plant biomass, exhibits crystallinity, because two or more cellulose molecules are bonded to each other through hydrogen bonding. In the present invention, such cellulose exhibiting crystallinity may be used as a raw material, but cellulose that is subjected to treatment for reducing crystallinity and thus has reduced crystallinity may be used. As the cellulose having reduced crystallinity, cellulose in which the crystallinity is partially reduced or cellulose in which the crystallinity is completely or almost completely lost may be used. The kind of the treatment for reducing crystallinity is not particularly limited, but treatment for reducing crystallinity capable of breaking the hydrogen bonding and at least partially generating a single-chain cellulose molecule is preferably employed. By using as the raw material cellulose at least partially containing the single-chain cellulose molecule, hydrolysis efficiency can be significantly improved.

In a substrate containing hemicellulose and lignin, hemicellulose and lignin surround cellulose and exist in a state complexly intertwined with each other. In the present invention, a substrate in such a state can be used as a raw material, as well as a substrate in which hemicellulose and lignin are untangled. A raw material in which hemicellulose and lignin are untangled have an improved contact property with a solid substrate, to thereby improve the hydrolysis efficiency.

As a method of breaking the hydrogen bonding between cellulose molecules and a method of untangling hemicellulose and lignin, there is given, for example, pulverization treatment. The pulverization means is not particularly limited as long as the means has a function to enable fine pulverization. For example, the mode of the pulverization apparatus may be a dry mode or a wet mode. In addition, the pulverization system of the apparatus may be a batch system or a continuous system. Further, as a pulverization apparatus, an apparatus using the pulverizing force provided by impact, compression, shearing, friction and the like can be used.

Specific examples of the apparatus for pulverization treatment include: tumbling ball mills such as a pot mill, a tube mill, and a conical mill; vibrating ball mills such as a circular vibration type vibration mill, a rotary vibration mill, and a centrifugal mill; mixing mills such as a media agitating mill, an annular mill, a circulation type mill, and a tower mill; jet mills such as a spiral flow jet mill, an impact type jet mill, a fluidized bed type jet mill, and a wet type jet mill; shear mills such as a Raikai mixer and an angmill; colloid mills such as a mortar and a stone mill; impact mills such as a hammer mill, a cage mill, a pin mill, a disintegrator, a screen mill, a turbo mill, and a centrifugal classification mill; and a planetary ball mill as a mill of a type that employs rotation and revolution movements.

In the hydrolysis using a solid catalyst, a rate of the reaction is limited by the degree of contact between the solid substrate and the solid catalyst. Therefore, as a method of improving reactivity, preliminarily mixing the solid substrate and the solid catalyst, followed by pulverizing the mixture simultaneously (hereinafter referred to as “simultaneous pulverization treatment”), is an effective way.

The simultaneous pulverization treatment may include pre-treatment for reducing the crystallinity of the substrate in addition to the mixing. From such viewpoint, the pulverization apparatus is preferably a tumbling ball mill, a vibrating ball mill, a mixing mill, or a planetary ball mill, which is used for the pre-treatment for reducing the crystallinity of the substrate, more preferably a pot mill classified as the tumbling ball mill, a media agitating mill classified as the mixing mill, or the planetary ball mill. Further, the reactivity tends to increase when a raw material obtained by the simultaneous pulverization treatment for the solid catalyst and the solid substrate has a high bulk density. Therefore, it is more preferred to use the tumbling ball mill, the mixing mill, or the planetary ball mill that can apply a strong compression force enough to allow a pulverized product of the solid catalyst to dig into a pulverized product of the solid substrate.

A ratio between the solid catalyst and the solid substrate to be subjected to the simultaneous pulverization treatment is not particularly limited. From the viewpoints of hydrolysis efficiency in a reaction, a decrease in a substrate residue after the reaction, and a recovery rate of a produced sugar, the mass ratio between the solid catalyst and the solid substrate is preferably 1:100 to 1:1, more preferably 1:10 to 1:1.

In each of the raw material obtained by separately pulverizing the substrate and the raw material obtained by simultaneously pulverizing the substrate and the catalyst, the average particle diameter after the fine pulverization (median diameter: particle diameter at a point where the cumulative volume curve determined based on the total powder volume defined as 100% crosses 50%) is from 1 to 100 μm, preferably from 1 to 30 μm, more preferably from 1 to 20 μm from the viewpoint of improving reactivity.

For example, when the particle diameter of a raw material to be treated is large, in order to efficiently perform the pulverization, preliminary pulverization treatment may be performed before the fine pulverization with, for example: a coarse crusher such as a shredder, a jaw crusher, a gyratory crusher, a cone crusher, a hammer crusher, a roll crusher or a roll mill; or a medium crusher such as a stamp mill, an edge runner, a cutting/shearing mill, a rod mill, an autogenous mill or a roller mill. The time for treating the raw material is not particularly limited as long as the raw material can be homogeneously and finely pulverized by the treatment.

[Determination of the Concentration of Inhibitor]

Hydrolysis of a plant biomass is inhibited when hydroxide ions and cations, which are derived from an alkaline agent used in the pretreatment of the hydrolysis reaction of the plant biomass as a raw material, and the like, exist in the reaction solution, to thereby lower the conversion and glucose saccharification rate. The inhibition can be eliminated by adding a specific amount of acid to the reaction solution according to the equivalent concentrations of the hydroxide ions and cations. The amount of the acid to be added to eliminate the inhibition can be calculated by determining the concentrations of hydroxide ions and cations as an inhibitor.

The equivalent concentration of hydroxide ions in the reaction solution can be determined from the measured pH by the following equation.

The equivalent concentration of hydroxide ions (mol/l; abbreviated as “N”)=10^{(pH-14)} [Equation 1]

The cations in the reaction solution in the present invention are alkali metal ions, alkaline earth metal ions, ammonium ions and the like derived from the plant biomass as a raw material, a solid catalyst and/or from an alkaline agent used in the pretreatment of the hydrolysis reaction. K⁺, Na⁺, Mg²⁺, Ca²⁺ and NH₄⁺ accounts for the majority of the cations.

The equivalent concentration of the cations in the reaction solution can be comprehensively determined from the measurement results by ion chromatography, indophenol blue absorptiometry, inductively-coupled plasma (ICP), electron probe microanalyzer (EPMA), electron spectroscopy for chemical analysis (ESCA), secondary ion mass spectrometry (SIMS) and atomic absorption spectrophotometry. It is preferable to use ion chromatography because it enables direct and high-sensitivity measurement of the main cations in the reaction solution at once.

[Acid]

As an acid, inorganic mineral acid such as hydrochloric acid, sulfuric acid, nitric acid, phosphoric acid and boric acid; organic carboxylic acid such as acetic acid, formic acid, phthalic acid, lactic acid, malic acid, fumaric acid, citric acid and succinic acid; organic sulfonic acid such as methane sulfonic acid, ethane sulfonic acid, benzene sulfonic acid and toluene sulfonic acid; may be used alone or two or more thereof in combination. Among these, inorganic mineral acid is preferable because the acid per se is less likely to be decomposed and deteriorated during hydrothermal treatment, and has less inhibitory effect at the time of using sugar as an objective product, and sulfuric acid, hydrochloric acid and nitric acid are more preferable.

The lower limit and upper limit of the acid concentration can be set from the viewpoints of facilitating rapid recovery of the glucose saccharification rate, and suppressing the excessive degradation of glucose and the acid corrosion, respectively. It is desirable to allow acid in the reaction solution in the equivalent concentration in the range of 30 to 1,000%, preferably 50 to 500%, more preferably 100 to 300% of the equivalent concentration of the cations in the reaction solution.

[Hydrolysis Reaction (Hydrothermal Treatment)]

The hydrolysis using a reagent biomass as a substrate is performed by heating the substrate in the presence of water, preferably with the addition of a solid catalyst, at a temperature that allows for a pressurized state. As the highest reaction temperature in the heating that allows for a pressurized state and the retention time at the temperature, a range of from 110 to 380° C. and a range of 0 to 60 minutes are appropriate. A relatively high temperature is preferred from the viewpoint of promptly performing its hydrolysis of cellulose and/or hemicellulose; suppressing conversion of glucose and/or xylose, which are a product, into another sugar; and excessive degradation into 5-hydroxymethyl furfural and the like. For example, it is appropriate to set the maximum reaction temperature and the retention time within a range of from 170 to 320° C. and for 0 to 30 minutes, more preferably from 180 to 300° C. and for 0 to 15 minutes, and still more preferably from 200 to 250° C. and for 0 to 5 minutes. The retention time of 0 minute means to lower the temperature immediately after reaching the highest temperature.

In the present invention, hydrolysis using an actual biomass containing cellulose and hemicellulose as a substrate is conducted as a hydrothermal treatment by heating the substrate in the presence of water, preferably with the addition of a solid catalyst, at a temperature that allows for a pressurized state. The treatment is conducted in two processes: i.e. a first process of mainly obtaining xylose and a second process of mainly obtaining glucose.

The pH of the mixture containing a plant biomass, a solid catalyst, acid and water before the hydrothermal treatment (right before the first process) is preferably 1.0 to 4.0. As the highest reaction temperature in the heating that allows for a pressurized state and the retention time at the temperature in the first process, a range of from 140 to 210° C. for 0 to 60 minutes is appropriate. From the viewpoint of suppressing the hydrolysis of cellulose and promoting the hydrolysis of hemicellulose, a range is preferably from 150 to 210° C. for 0 to 30 minutes, more preferably from 160 to 200° C. for 0 to 10 minutes, still more preferably from 170 to 190° C. and for 0 to 5 minutes, and most preferably from 175 to 185° C. and for 0 to 3 minutes.

As the highest reaction temperature in the heating that allows for a pressurized state and the retention time at the temperature in the second process, a range of from 180 to 250° C. for 0 to 60 minutes is appropriate. From the viewpoint of promptly performing its hydrolysis of cellulose; suppressing conversion of glucose as being a product into another sugar; and excessive degradation into 5-hydroxymethyl furfural and the like, the range is preferably from 185 to 240° C. for 0 to 30 minutes, more preferably from 190 to 230° C. and for 0 to 5 minutes, and most preferably from 195 to 220° C. and for 0 to 3 minutes.

In the method of the present invention conducting hydrolysis in two processes, after the completion of the first process, a solubilized reaction product, an unreacted substrate which remained as an insoluble solid content, and a solid catalyst are separated and collected by solid-liquid separation. Then, water and acid are added to the insoluble solid content to thereby conduct the second process.

The apparatus to perform solid-liquid separation is not particularly limited as long as it is capable of separation. For example, a centrifugal separator, centrifugal filter, filter press, Oliver filter, drum filter, ultrafiltration (UF) membrane device, microfiltration (MF) membrane device, and reverse osmosis (RO) membrane device can be used. At the time of solid-liquid separation, it is possible to supply washing water to the apparatus to wash and remove the soluble component contained in the insoluble solid content.

The hydrolysis of cellulose and/or hemicellulose in the method of the present invention is usually carried out in a closed vessel such as an autoclave. Therefore, even if the pressure at the start of the reaction is ordinary pressure, the reaction system becomes a pressurized state when heated at the above-mentioned temperature. Further, the closed vessel may be pressurized before the reaction or during the reaction to perform the reaction. The pressure for pressurization is, for example, from 0.1 to 30 MPa, preferably from 1 to 20 MPa, more preferably from 2 to 10 MPa. In addition to the closed vessel, the reaction liquid may be heated and pressurized to perform the reaction while the reaction liquid is allowed to flow by a high-pressure pump.

The amount of water for hydrolysis is at least one necessary for hydrolysis of the total amount of cellulose and/or hemicellulose. In consideration of, for example, fluidity and stirring property of the reaction mixture, the mass ratio between the water and cellulose and/or hemicellulose is preferably 1:1 to 500:1, more preferably 2:1 to 200:1.

The atmosphere of the hydrolysis is not particularly limited. From an industrial viewpoint, the hydrolysis is preferably carried out under an air atmosphere, or may be carried out under an atmosphere of gas other than air, such as oxygen, nitrogen, or hydrogen, or a mixture thereof.

The hydrolysis reaction may be carried out in a batch fashion or a continuous fashion. The reaction is preferably carried out while stirring the reaction mixture.

The present invention enables production of a sugar-containing liquid, which mainly comprises glucose and/or xylose and is low in excessive degradation products, through hydrolysis at a relatively high temperature for a relatively short time.

From the viewpoint of suppressing conversion of glucose and/or xylose into another sugar and improving the yield of glucose and/or xylose, it is desirable to cool the reaction liquid after the completion of heating. From the viewpoint of increasing the yield of glucose and/or xylose, the cooling of the reaction liquid is preferably carried out as fast as possible to a temperature at which conversion of glucose and/or xylose into other sugars and excessive degradation into 5-hydroxymethyl furfural and the like are not substantially caused. For example, the cooling may be carried out at a rate in a range of from 1 to 200° C./min and is preferably carried out at a rate in a range of from 5 to 150° C./min. The temperature at which conversion of glucose into another sugar is not substantially caused is, for example, 150° C. or less, preferably 110° C. or less. That is, the reaction liquid is suitably cooled to 150° C. or less at a rate in a range of from 1 to 200° C./min, preferably from 5 to 150° C./min, more suitably cooled to 110° C. or less at a rate in a range of from 1 to 200° C./min, preferably from 5 to 150° C./min.

The reaction liquid obtained in the second process can be separated into a liquid phase mainly containing glucose and a solid phase containing a solid catalyst and an unreacted substrate by the solid-liquid separation treatment and be recovered. The apparatus to perform solid-liquid separation is not particularly limited as long as it is capable of separation. For example, a centrifugal separator, centrifugal filter, filter press, Oliver filter, drum filter, ultrafiltration (UF) membrane device, microfiltration (MF) membrane device, and reverse osmosis (RO) membrane device can be used. At the time of solid-liquid separation, it is possible to supply washing water to the apparatus to wash and remove the soluble component contained in the insoluble solid content.

### EXAMPLES

The present invention is hereinafter described in more details by way of Examples and Comparative Examples. However, the present invention is by no means limited to the descriptions of Examples and Comparative Examples.

[Solid Catalyst and Solid Substrate]

In each of Examples and Comparative Examples, dry activated carbon powder BA50 (manufactured by Ajinomoto Fine-Techno Co., Inc.) (herein after referred to as “a carbon catalyst”) was used as a solid catalyst, and bagasse as being an actual biomass subjected to the pretreatment as described below was used as a solid substrate.

[Pretreatment of Bagasse]

Heating treatment was conducted by placing 430 g of dry bagasse (cellulose content: 43%, hemicellulose content: 20%, lignin content: 20%) coarsely pulverized with a rotary speed mill (manufactured by FRITSCH JAPAN CO., LTD.; sieve rings of 0.12 mm) and 5 liters of water in a high-pressure reactor (internal volume: 10 liters, desktop reactor OML-10 manufactured by OM LAB-TECH CO., LTD; made of SUS316; provided with helical stirring blades) at a temperature of 200° C. for nine minutes while stirring at 600 rpm. After cooling, the resultant was subjected to centrifugal filtration with a centrifugal filtration device (H-122 manufactured by Kokusan Co., Ltd.; cotton filter cloth) at 3,000 rpm, to collect 1,000 g of water-containing solid content from which a supernatant was removed (water content: 70%, 300 g in terms of a dry product).

Next, 1,000 g of the collected water-containing solid content was again placed in a high-pressure reactor (internal volume: 10 liters, desktop reactor OML-10 manufactured by OM LAB-TECH CO., LTD; made of SUS316; provided with helical stirring blades) with 50 g of NaOH, 55 g of Na₂S and 4 liters of water; and subjected to heat treatment at a temperature of 160° C. for 60 minutes while stirring at 600 rpm. After cooling, the resultant was subjected to centrifugal filtration with a centrifugal filtration device (H-122 manufactured by Kokusan Co., Ltd.; cotton filter cloth) at 3,000 rpm to remove the supernatant. After supplying water in an amount of 50 liters in total to wash the cake, 551 g of dehydrated water-containing solid content (water content: 71%, dry product: 160 g; pH: 7) was collected and dried in an oven at 80° C. for 24 hours (hereinafter abbreviated as “pretreated bagasse”).

The ingredient contents in the pretreated bagasse were determined by analysis methods (Technical Report NREL/TP-510-42618) of NREL (the National Renewable Energy Laboratory). The results were cellulose of 59%, hemicellulose of 27% (xylose of 25% and arabinose of 2%), and lignin of 9.5%.

[Mixed and Pulverized Raw Material]

10.00 g of pretreated bagasse, 1.54 g of carbon catalyst (mass ratio of the solid component of the substrate and catalyst was 6.5:1.0) were loaded in a 3,600 ml-volume ceramic pot mill together with 2,000 g of alumina balls each having a diameter of 1.5 cm. The ceramic pot mill was set to a desktop pot mill rotating table (manufactured by NITTO KAGAKU Co., Ltd.; desktop pot mill type ANZ-51S). The content was pulverized through ball mill treatment at 60 rpm for 48 hours. The obtained raw material is hereinafter referred to as a mixed and pulverized raw material.

### Examples 1 to 4, Comparative Examples 1 to 5

### Hydrolysis Reaction in the First Stage (First Process)

After putting 0.374 g of the mixed and pulverized raw material (2.00 mmol in terms of C₆H₁₀O₅) and 40 ml of hydrochloric acid (115 ppm, pH: 2.5) in a high-pressure reactor (internal volume: 100 ml, autoclave manufactured by OM LAB-TECH CO., LTD, made of Hastelloy (trademark) C22), the reaction liquid was rapidly heated from room temperature to the highest reaction temperature as shown in Table 1 while being stirred at 600 rpm. After the reaction solution reached the highest reaction temperature and was retained for a time period as shown in Table 1, the heating was stopped right away, and the reactor was air-cooled to room temperature. After the cooling, the reaction liquid was separated using a membrane filter into a liquid and a solid. The products in the liquid phase were quantitatively analyzed for hexose (glucose, cello-oligosaccharide (DP=2 to 6), mannose, fructose, levoglucosan, 5-hydroxymethyl furfural (5 HMF)) and pentose (xylose and arabinose) with a high-performance liquid chromatograph manufactured by Shimadzu Corporation (Condition 1: column: Shodex (trademark) SH-1011, mobile phase: water at 0.5 mL/min, 50° C., detection: differential refractive index; Condition 2: column: Phenomenex Rezex RPM-Monosaccharide Pb++ (8%), mobile phase: water at 0.6 mL/min, 70° C., detection: differential refractive index). The yields of hexose and hexose were determined by the following equation.

Yield of hexose (%)={(amount of carbon in the target component)/(amount of carbon in the added cellulose)}×100

Yield of pentose (%)={(amount of carbon in the target component)/(amount of carbon in the added hemicellulose)}×100 [Equation 2]

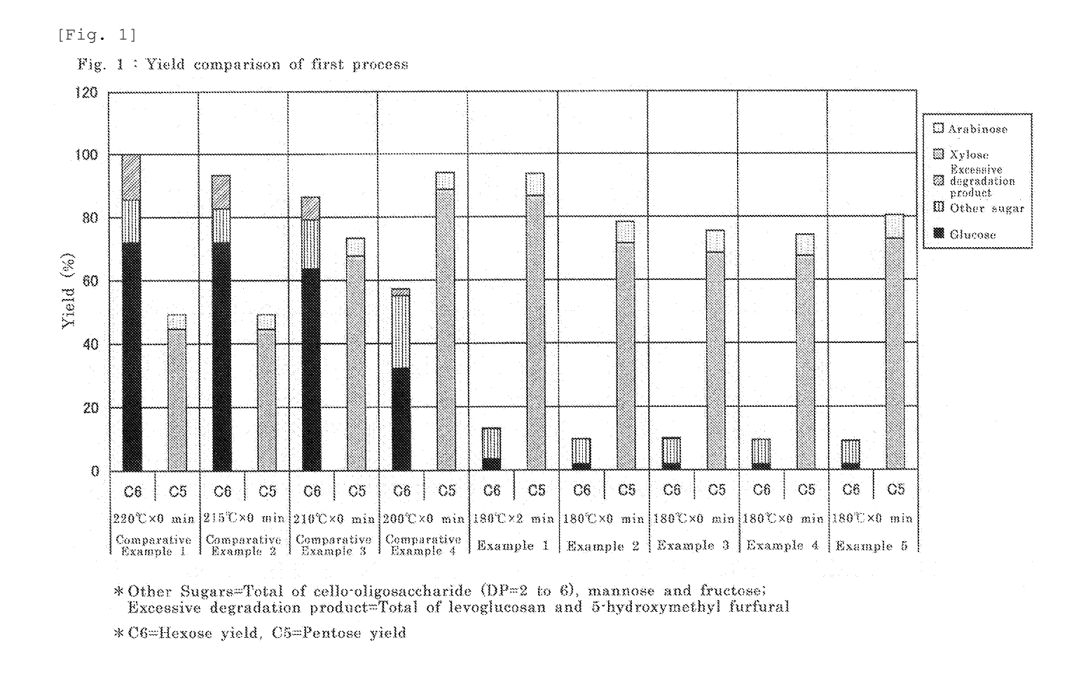

The results are shown in Table 2 and FIG. 1. Regarding the behavior of glucose yield under the condition of the highest reaction temperature of 180 to 220° C., the highest yield of 72% was attained under the conditions of 220° C. and retention time of 0 minute (Comparative Example 1). The yield decreased as the highest reaction temperature drops. The yield was 2% under the condition of 180° C. and retention time of 0 minute (Examples 2 to 4 and Comparative Example 5), and it was confirmed that the condition produced very little glucose.

On the other hand, regarding xylose, the highest yield of 89% was attained under the condition of the highest reaction temperature of 200° C. and the retention time of 0 minute (Comparative Example 4), and the yield decreased in either case of setting the condition at a higher temperature (Comparative Examples 1 to 3) or a lower temperature (Examples 1 to 4 and Comparative Example 5). It is presumed that under the condition of a temperature higher than 200° C., the generated xylose degraded due to large heating load to thereby decrease the xylose yield, while the progress of the hydrolysis of hemicellulose was prohibited due to small heating load to thereby decrease the xylose yield under the condition of a temperature lower than 200° C.

From the viewpoint of fractionating and obtaining glucose and xylose at a high yield, as the condition for hydrolysis in the first stage in order to obtain xylose, the maximum reaction temperature is preferably 180° C. (Examples 1 to 4 and Comparative Example 5) which produces almost no glucose.

[Hydrolysis Reaction in the Second Stage (Second Process)]

The total amount of each of the solids obtained in Examples 1 to 4 and Comparative Example 5 was returned with no drying to a high-pressure reactor (internal volume: 100 ml; manufactured by OM LAB-TECH CO., LTD; made of Hastelloy C22). 40 ml of hydrochloric acid (115 ppm, pH: 2.5) was added thereto, and the second-stage hydrolysis reaction was conducted in the same procedure as in the above-mentioned first-stage hydrolysis reaction at the highest reaction temperature and for a retention time as shown in Table 1.

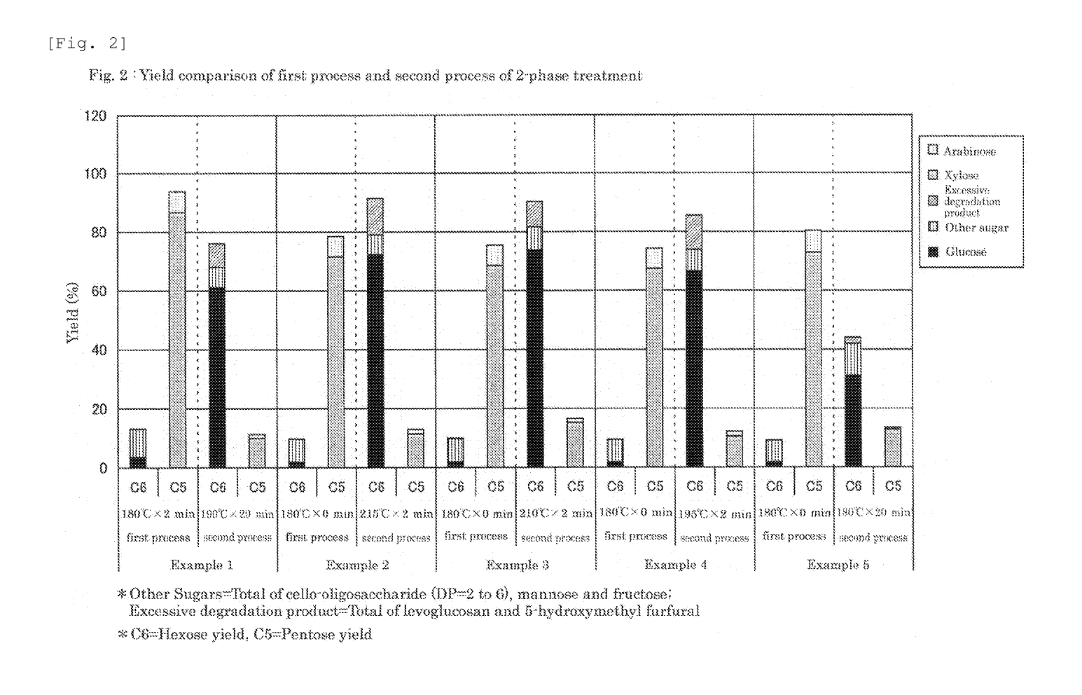

The results are shown in Table 2 and FIG. 2. Regarding the glucose yield by the second-stage hydrolysis at a highest reaction temperature of 195 to 215° C., the yield showed the highest rate of 74% under the condition of 210° C. and retention time of 2 minutes (Example 3), 72% under the condition of 215° C. and retention time of 2 minutes (Example 2), and 67% under the condition of 195° C. and retention time of 2 minutes (Example 4), and it was confirmed that the condition generally resulted in a yield as high as 70%. On the other hand, regarding the glucose yield at a highest reaction temperature of 190° C. or lower, while the yield of 61% was attained at 190° C. (Example 1), the yield remained at 31% at 180° C. (Comparative Example 5) under the condition of prolonged retention time of 20 minutes. It was confirmed that since the hydrolysis performance is decreased at a highest reaction temperature of 190° C. or lower, it requires significant extension of the retention time in order to obtain a high glucose yield.

TABLE 1

| | | Highest reaction | Retention |
|---|---|---|---|
| No. | Hydrolysis | temperature (° C.) | time (min.) |
| Comparative | First process | 220 | 0 |
| Example 1 | | | |
| Comparative | First process | 215 | 0 |
| Example 2 | | | |
| Comparative | First process | 210 | 0 |
| Example 3 | | | |
| Comparative | First process | 200 | 0 |
| Example 4 | | | |
| Example 1 | First process | 180 | 2 |
| | Second process | 190 | 20 |
| Example 2 | First process | 180 | 0 |
| | Second process | 215 | 2 |
| Example 3 | First process | 180 | 0 |
| | Second process | 210 | 2 |
| Example 4 | First process | 180 | 0 |
| | Second process | 195 | 2 |
| Comparative | First process | 180 | 0 |
| Example 5 | Second process | 180 | 20 |

TABLE 2

| | | Hexose yield (%) | | | | | | | Pentose yield (%) | | | Total yield |
|---|---|---|---|---|---|---|---|---|---|---|---|---|
| No. | Hydrolysis | Glc | Olg | Man | Frc | Lev | HMF | Total | Xyl | Arb | Total | (hexose + pentose) |
| Comparative | 1st process | 72 | 4 | 5 | 4 | 4 | 12 | 101 | 45 | 5 | 49 | 151 |
| Example 1 | | | | | | | | | | | | |
| Comparative | 1st process | 72 | 3 | 4 | 4 | 4 | 7 | 93 | 45 | 5 | 49 | 143 |
| Example 2 | | | | | | | | | | | | |
| Comparative | 1st process | 64 | 9 | 4 | 3 | 3 | 4 | 86 | 68 | 6 | 73 | 160 |
| Example 3 | | | | | | | | | | | | |
| Comparative | 1st process | 32 | 19 | 3 | 1 | 1 | 1 | 57 | 89 | 5 | 94 | 151 |
| Example 4 | | | | | | | | | | | | |
| Example 1 | 1st process | 4 | 10 | 0 | 0 | 0 | 0 | 13 | 87 | 7 | 94 | 107 |
| | 2nd process | 61 | 4 | 1 | 2 | 2 | 6 | 76 | 10 | 1 | 11 | 87 |
| | Total | 65 | 14 | 1 | 2 | 2 | 6 | 89 | 97 | 8 | 105 | 194 |
| Example 2 | 1st process | 2 | 8 | 0 | 0 | 0 | 0 | 10 | 72 | 7 | 78 | 88 |
| | 2nd process | 72 | 2 | 2 | 3 | 3 | 9 | 91 | 11 | 2 | 13 | 104 |
| | Total | 74 | 10 | 2 | 3 | 4 | 9 | 101 | 83 | 8 | 91 | 193 |
| Example 3 | 1st process | 2 | 8 | 0 | 0 | 0 | 0 | 10 | 69 | 7 | 75 | 85 |
| | 2nd process | 74 | 4 | 2 | 3 | 4 | 5 | 90 | 15 | 1 | 17 | 107 |
| | Total | 76 | 12 | 2 | 3 | 4 | 5 | 100 | 84 | 8 | 92 | 192 |
| Example 4 | 1st process | 2 | 8 | 0 | 0 | 0 | 0 | 10 | 68 | 7 | 74 | 84 |
| | 2nd process | 67 | 3 | 1 | 3 | 3 | 9 | 86 | 11 | 2 | 12 | 98 |
| | Total | 68 | 11 | 1 | 3 | 3 | 9 | 95 | 78 | 8 | 86 | 182 |
| Comparative | 1st process | 2 | 7 | 0 | 0 | 0 | 0 | 9 | 73 | 8 | 80 | 90 |
| Example 5 | 2nd process | 31 | 9 | 1 | 1 | 1 | 1 | 44 | 13 | 1 | 14 | 58 |
| | Total | 33 | 17 | 1 | 1 | 1 | 1 | 53 | 86 | 8 | 94 | 147 |

* Hexose yield = Yield of the compounds derived from cellulose. The ratio of the amount of carbon in the target components to the amount of carbon in the added cellulose.
* Pentose yield = Yield of the compounds derived from hemicellulose. The ratio of the amount of carbon in the target components to the amount of carbon in the added hemicellulose.
* Glc = glucose, Olg = cello-origosaccharide (DP = 2 to 6), Man = mannose, Frc = fructose, Lev = levoglucosan, HMF = 5-hydroxymethyl furfural (=target components of the hexose yield)
*Xyl = xylose, Arb = arabinose (=target components of the pentose yield)

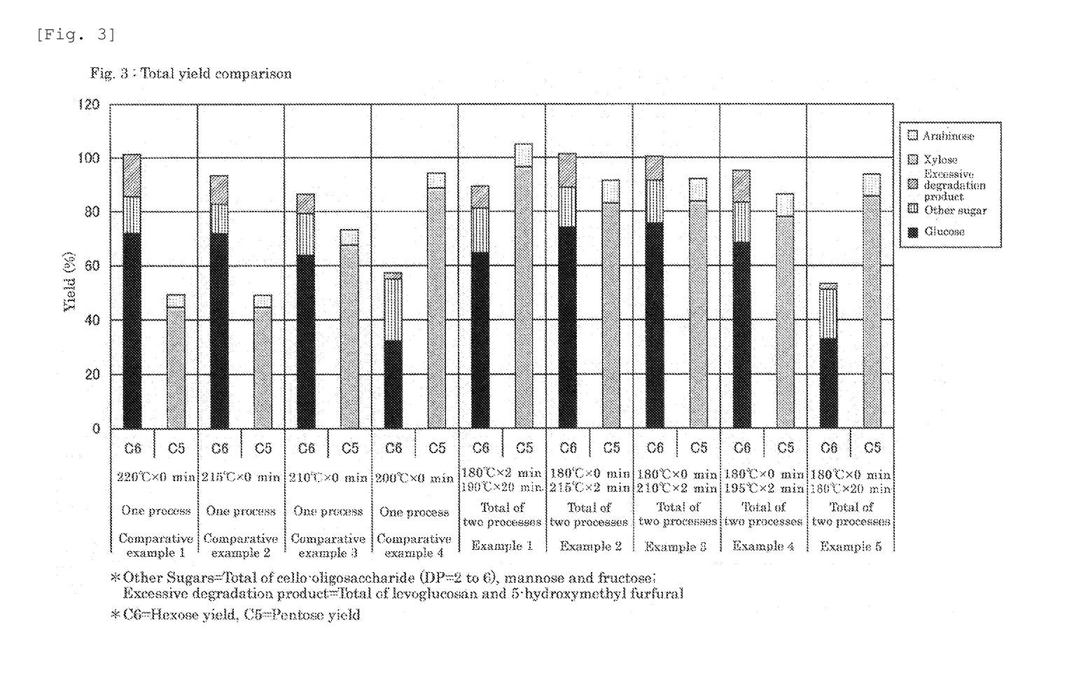

The total glucose yield and the total xylose yield in each of Examples 1 to 4 and Comparative Examples 1 to 5 (FIG. 3) were 76% for glucose and 84% for xylose (74% for glucose and 69% for xylose obtained by fractionation) in Example 3, 74% for glucose and 83% for xylose (72% for glucose and 72% for xylose obtained by fractionation) in Example 2, 68% for glucose and 78% for xylose (67% for glucose and 68% for xylose obtained by fractionation) in Example 3, 65% for glucose and 97% for xylose (61% for glucose and 87% for xylose obtained by fractionation) in Example 4, and both of cellulose and xylose were obtained at a yield as high as 60% or higher. Regarding Comparative Examples 1 to 4, in which the hydrolysis was conducted in one stage, none of the examples achieved a high-yield result. When the reaction liquid was directly subjected to the second-process hydrolysis without collecting the liquid phase by solid-liquid separation after the first-process hydrolysis, xylose contained in the liquid phase is more liable to degrade by heat compared to cellulose and glucose, and xylose is decomposed in the second process. Thus, the xylose yield decreases compared with the case where the liquid phase is not collected. As can be seen from the foregoing, it can be said that the high yield attained in Examples 1 to 4 is an effect generated by conducting the solid-liquid separation between the first- and second-stage hydrolysis reactions.

### INDUSTRIAL APPLICABILITY

According to the present invention, both of xylose and glucose can be fractionated and obtained at a high yield by conducting the hydrolysis in two stages in the hydrolysis reaction of a plant biomass through a hydrothermal reaction.

1. A method for hydrolyzing a plant biomass, comprising a first process of heating a mixture containing a plant biomass, a solid catalyst, acid and water, and a second process for heating the mixture containing a solid content separated from the reaction solution after the first process, acid and water; wherein the highest heating temperature in the second process is higher than that in the first process.

2. The method for hydrolyzing a plant biomass as claimed in claim 1, wherein the highest heating temperature is 140 to 210° C. and the retention time at the temperature is 0 to 60 minutes in the first process, and the highest heating temperature is 180 to 250° C. and the retention time at the temperature is 0 to 60 minutes in the second process.

3. The method for hydrolyzing a plant biomass as claimed in claim 1, wherein the pH of the mixture containing a plant biomass, a solid catalyst, acid and water right before the first process is 1.0 to 4.0.

4. The method for hydrolyzing a plant biomass as claimed in claim 1, wherein the acid is at least one member selected from inorganic mineral acid, organic carboxylic acid and organic sulfonic acid.

5. The method for hydrolyzing a plant biomass as claimed in claim 4, wherein the inorganic mineral acid is at least one member selected from hydrochloric acid, sulfuric acid, nitric acid, phosphoric acid and boric acid.

6. The method for hydrolyzing a plant biomass as claimed in claim 1, wherein the solid catalyst is a carbon material.

7. The method for hydrolyzing a plant biomass as claimed in claim 6, wherein the carbon material is alkali-activated carbon, steam-activated carbon, or mesoporous carbon.

8. The method for hydrolyzing a plant biomass according to claim 1, wherein the plant biomass contains cellulose and/or hemicellulose.

9. The method for hydrolyzing a plant biomass according to claim 1 wherein the plant biomass is subjected to delignification treatment.

10. A method for producing glucose, characterized in using the method for hydrolyzing a plant biomass claimed in claim 1.

11. A method for producing xylose, characterized in using the method for hydrolyzing a plant biomass claimed in claim 1.
